(19) United States
(12) Patent Application Publication
(10) Pub. No.: US 2025/0224569 A1
(43) Pub. Date: Jul. 10, 2025

(54) Fiber-Optic Ferrule with Slotted Blind Hole for Improved Epoxy Flow and Fiber Positioning

(71) Applicant: US Conec Ltd., Hickory, NC (US)

(72) Inventor: Daniel D. Kurtz, Huntersville, NC (US)

(21) Appl. No.: 18/407,911

(22) Filed: Apr. 19, 2024

Related U.S. Application Data
(60) Provisional application No. 63/441,711, filed on Jan. 27, 2023.

(51) Int. Cl. G02B 6/36; G02B 6/38

(52) U.S. Cl. CPC G02B 6/3644; G02B 6/3885; G02B 6/3889

(57) ABSTRACT

A fiber optic ferrule has a set of optical fiber support structures that includes a slotted blind hole to assist in the application of epoxy to the optical fibers and fiber optic ferrule. There is an entrance surface within the slotted blind holes against which the optical fibers may be disposed. The slotted blind holes may be formed within a portion of a first wall and a second wall adjacent a front end of the fiber optic ferrule.

### REFERENCE TO RELATED CASE

This application claims priority under 35 U.S.C. § 119 (e) to U.S. provisional application No. 63/441,711 filed on Jan. 27, 2023, the contents of which are hereby incorporated by reference in their entirety.

### BACKGROUND OF THE INVENTION

Typically, for lensed fiber-optic ferrules (or “lensed ferrules”) with internal and/or external lenses, optical fibers are terminated within a body of the fiber-optic ferrule. That is, the optical fibers inserted within the fiber-optic ferrule are not exposed at an end face of the fiber-optic ferrule, as is the case with non-lensed MT ferrules. Conventional lensed ferrules with blind holes, such as those shown in Applicant's U.S. Pat. No. 9,983,365 (Atty. Dkt. USCO-056) have internal optical fiber stop planes in optical fiber openings where the optical fibers may stop. There is an epoxy well forward of the openings in a direction toward the front or mating end of the ferrule, before the blind hole, which may have an internal lens positioned for each optical fiber to better collimate the optical beam and reduce back reflection. Yet other lensed ferrules, such as the one shown in Applicant's U.S. Pat. No. 10,585,248 (Atty. Dkt. USCO-078, “the '248 patent”), discloses that the ends of the fibers (fiber tips) be positioned inside the blind hole or very close to the blind hole. The optical fibers cross over the epoxy well in these lensed ferrules.

In these conventional and other lensed ferrules with internal lenses, there is a challenge of ensuring that (a) the epoxy fully fills the blind hole, and (b) that during curing, the epoxy can flow properly without creating any air bubbles/gaps within the blind hole or elsewhere. Presence of air gaps in cured epoxy adds to back reflections and is undesirable for optical performance of the fiber-optic ferrule.

In addition, there are lensed ferrules that have groove-like structures, such as the ones shown in Applicant's PCT/US2021/030674 (published as WO 2021/226101, Atty. Dkt. USCO-132-INT), to support the optical fibers placed therein. However, such grooves are wide open on the top, i.e., the internal surface of the grooves does not hinder or block any undesirable out of axis movement of the optical fibers. These grooves may have bumps to assist holding the fibers prior to curing and the fibers are positioned solely under gravity. However, there may be instances when the geometry of the grooves may cause the fibers to slip out therefrom.

Thus, there is a need for lensed optical ferrules that ensure better epoxy flow inside the fiber-optic ferrule to avoid formation of air gaps. Further, a better structure to hold the optical fibers is needed to prevent slippage out of the optical-fiber support structure at any point during termination and curing. Various aspects of this disclosure address these issues and provide a solution to the aforementioned challenges

### SUMMARY OF THE INVENTION

According to one aspect, the present invention is directed to a fiber optic ferrule that includes a main body having a front end and a rear end, and a top side, the rear end having a rear opening to receive at least two optical fibers, at least one window on the top side, a first set of optical fiber support structures in the main body disposed between the front end and the back end and configured to receive the at least two optical fibers, and a second set of optical fiber support structures in the main body disposed between the front end and the first set of optical fiber support structures and configured to receive the at least two optical fibers from the first set of optical fiber support structures, the second set of optical fiber support structures aligned with the first set of optical fiber support structures along a longitudinal axis between the front and the rear end of the fiber optic ferrule, and the second set of optical fiber support structures includes a plurality of blind holes configured to respectively receive the at least two optical fibers, wherein there is a first rearward facing wall lying in a first plane and a second rearward facing wall lying in a second plane, the first rearward facing wall and the second rearward facing wall off-set from each other, each of the plurality of blind holes passes through a portion of the first rearward facing wall and a portion of the second rearward facing wall, and wherein each of the plurality of blind holes has a slot at a top thereof.

In some embodiments, each of the plurality of blind holes has a radius and the slot at the top of the first rearward facing wall has a first distance that is less than the radius of each of the blind holes.

In some embodiments, the slot at the top of each of the second rearward facing walls subtends an angle α from a center of each of the blind hole.

In some embodiments, the angle α is less than 180 degrees.

In some embodiments, the angle α is less than 5 degrees.

In some embodiments, each of the plurality of blind holes has a most upper portion, the most upper portion is a second distance from the top of the first rearward facing wall.

In some embodiments, the second distance is less than 10 microns.

In some embodiments, there is a third rearward facing wall, the third rearward facing wall lying in a third plane, the first, second, and third rearward facing walls being parallel to but off-set from each other, a first plurality of the plurality of blind holes passes through a portion of the first rearward facing wall and a portion of the second rearward facing wall, and a second plurality of the plurality of the blind holes passes through a portion of the second rearward facing wall and the third rearward facing wall, and wherein each of the second plurality of blind holes also has a slot at a top thereof.

In yet another aspect, there is fiber optic ferrule that includes a main body having a front end and a rear end, a top side, the rear end having a rear opening to receive at least two optical fibers and epoxy, a first set of optical fiber support structures in the main body disposed between the front end and the back end and configured to receive the at least two optical fibers, a second set of optical fiber support structures in the main body disposed between the front end and the first set of optical fiber support structures and configured to receive the at least two optical fibers from the first set of optical fiber support structures, the second set of optical fiber support structures aligned with the first set of optical fiber support structures along a longitudinal axis between the front and the rear end of the fiber optic ferrule, wherein the second set of optical fiber support structures includes at least two slotted blind holes configured to respectively receive the at least two optical fibers rearward of an entrance surface of the at least two slotted blind holes, the at least two slotted blind holes each have a slot for epoxy flow, and an end face at the front end of the fiber-optic ferrule through which one or more optical beams to and/or from the at least two optical fibers pass through.

In some embodiments, each of the at least two slotted blind holes passes through a portion of a first rearward facing wall and also through a portion of a second rearward facing wall, the first rearward facing wall and the second rearward facing wall are parallel to and offset from one another and each of the at least two slotted blind holes has a slot on a top thereof.

And in yet another aspect, there is a fiber optic ferrule that includes a main body having a front end and a rear end, a top side, a bottom side and two opposing side surfaces joining the top side and the bottom side between the front end and the rear end, the fiber optic ferrule configured to receive at least two optical fibers, a set of optical fiber support structures in the main body disposed between the front end and rear end, the set of optical fiber support configured to receive the at least two optical fibers along a longitudinal axis between the front and the rear end of the fiber optic ferrule, wherein the set of optical fiber support structures includes slotted blind holes configured to respectively receive the at least two optical fibers rearward of an entrance surface of the slotted blind hole, the slotted blind hole having a slot for epoxy flow; and an end face at the front end of the fiber-optic ferrule through which one or more optical beams to and/or from the at least two optical fibers pass through.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a perspective view of a fiber optic ferrule according to the present invention;

FIG. 2 is a side perspective view of a front portion of a cross section of the fiber optic ferrule in FIG. 1;

FIG. 3 is a side elevational view of the front of the fiber optic ferrule in FIG. 1;

FIG. 4 is an enlarged portion of the front of the fiber optic ferrule in FIG. 1 illustrating a set of optical fiber support structures;

FIG. 5 is an elevation view of some of the optical fiber support structures in the fiber optic ferrule in FIG. 1; and

FIG. 6 an enlarged portion of the fiber optic ferrule in FIG. 1 illustrating another set of optical fiber support structures; and

### DETAILED DESCRIPTION OF THE INVENTION

Reference will now be made in detail to the present preferred embodiment(s) of the invention, examples of which are illustrated in the accompanying drawings. Whenever possible, the same reference numerals will be used throughout the drawings to refer to the same or like parts.

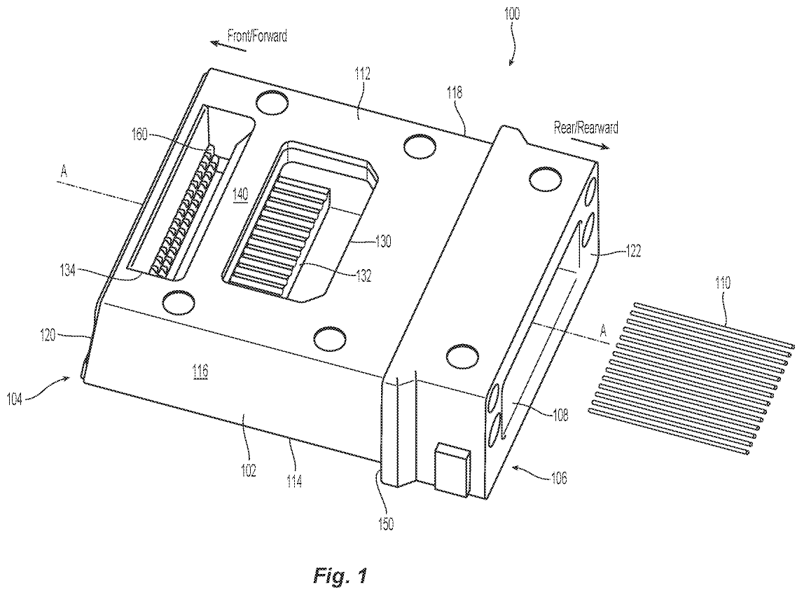

Illustrated in FIG. 1 is one embodiment of a fiber optic ferrule 100 according to the present invention. The fiber optic ferrule 100 has integral lenses and may therefore also be referred to as a lensed fiber optic ferrule, or a lensed ferrule.

As used herein, the term “front” and “forward” means that direction where the lensed ferrule would mate with another fiber optic ferrule or connector (having another ferrule) device, while the term “rear” or “rearward” is used to mean the direction from which the optical fibers enter into the lensed ferrule. So turning to FIG. 1, the front is the direction shown by the arrow and “back” or “rearward” is the opposite direction. Thus, the front of the lensed ferrule is pointed to the left in FIG. 1 and the rear or rearward end of the lensed ferrule is pointing to the right. Similarly, the top of the lensed ferrule is that side that has an opening into the fiber optic ferrule on the upper part of FIG. 1 while the bottom is on the opposite of the top side. Further, it will be appreciated that the optical fibers herein may be single mode or multi-mode.

The fiber optic ferrule 100 has a main body 102 and a front end 104 and a rear end 106 and extends along a longitudinal axis A. The rear end 106 has a rear opening 108 to receive a plurality of optical fibers 110 therein. The fiber optic ferrule 100 may receive at least two optical fibers 110 and more preferably 8-16 optical fibers. The optical fibers 110 may be single or multi-mode optical fibers with a single core or a plurality of cores. The fiber optic ferrule 100 has a top side 112 and a bottom side 114, the top side 112 and the bottom side 114 joined together by a first side 116 and the second side 118. The first side 116 and the second side 118 form the two opposing side surfaces of the main body 102 of the lensed ferrule 100. The front end 104 of the main body 102 has a front face 120 through which light beams from the optical fibers 110 pass and the rear end 106 has a rear face 122. The main body 102 has a first window 130 opening through the top side 112 and in communication with the rear opening 108. The first window 130 provides unblocked visual and/or mechanical access to a first set of optical fiber support structures 132 to support the plurality of optical fibers 110 that pass from the rear opening 108 into the main body 102 and underneath the first window 130. The fiber optic ferrule 100 also has a second window 134 disposed between the first window 130 and the front end 104. However there may only be one window (second window 134) in the fiber optic ferrule 100. The second window 134 may also be known as the epoxy window, where epoxy is inserted to retain the plurality of optical fibers 110 in the main body 102. It is also possible to introduce epoxy into the main body from the rear opening 108.

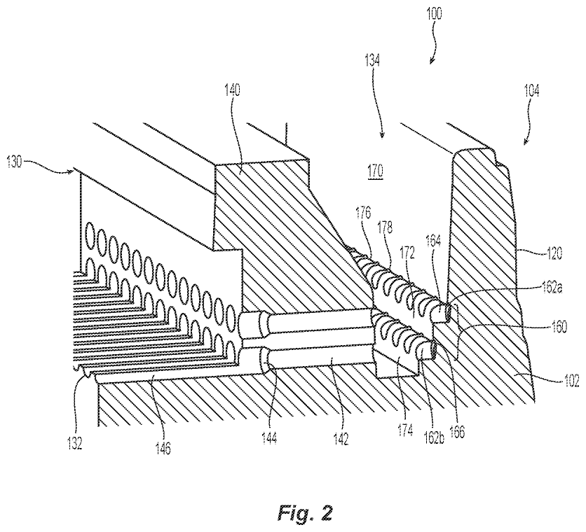

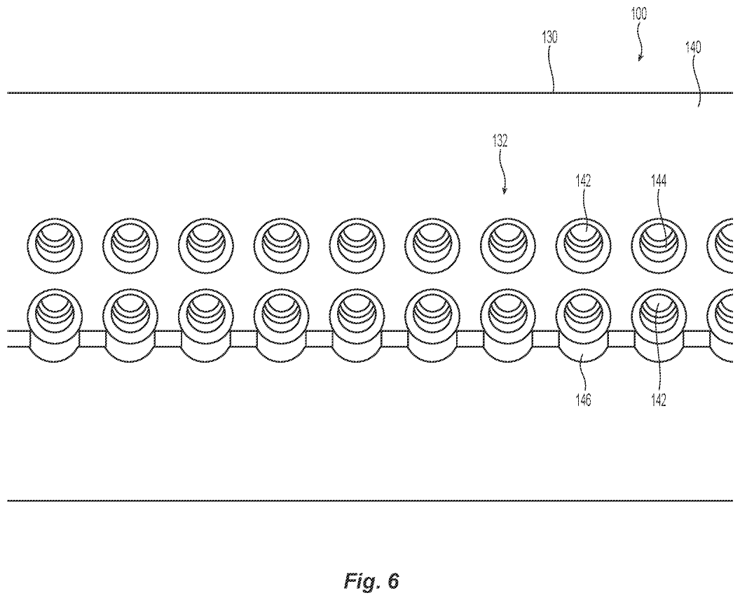

Between the first window 130 and the second window 134 is a divider or separator wall 140. There are openings 142 (micro-holes) in the separator wall 140 to allow the optical fibers 110 to be disposed within the second window 134. See FIGS. 2 and 6. Each of the openings 142 may have a chamfered portion 144 to assist in aligning the plurality of optical fibers 110 with the openings 142. Alternatively, the openings 142 may have no chamfering or only partial chamfering. As illustrated in FIG. 2, there may be two rows of openings 142, but there may also be only row or more than two rows of openings. As seen in FIGS. 2 and 6, there may also be a number of u-shaped grooves 146 to assist in aligning the optical fibers 110 with at least one of the rows of openings 142. The grooves 146 may also be v-shaped or have another shape and still come within the scope of the present invention.

The main body 102 may also include a shoulder 150 at the rear end 106 of the main body 102.

Turning to FIGS. 2-5, there is a second set of optical fiber support structures 160 that are aligned with the first set of optical fiber support structures 132 to receive the plurality of optical fibers 110. The second set of optical fiber support structures 160 include at least one and more preferably two rows 162a,162b of blind holes 164 that are present in the entrance surface 166 of the front portion of the main body 102. The number of rows in the first and second sets of optical fiber support structures 132,160 should be the same. At the end of each of the blind holes 164 is an entrance surface 166 that may be angled relative to the longitudinal axis A (i.e., tilted or non-perpendicular to the longitudinal axis). The entrance surface 166 is where the optical beams from the respective optical fibers 110 transition to the medium of the fiber optic ferrule 100. A tip of each of the optical fibers 110 is disposed within the blind holes 164, respectively, for example, at least 5 microns from the entrance surface 166. Alternatively, the tip of the optical fiber 110 may touch the entrance surface 166. The angle of the entrance surface 166 and the distance of the fiber tip therefrom are again determined by parameters depending on the ferrule material, the refractive index of the optical fiber, and the like. The front end 104 of the fiber optic ferrule 100 may also have an optional lens (internal to the lensed ferrule) at the front end to correct the aberrations from the angled entrance surface 166.

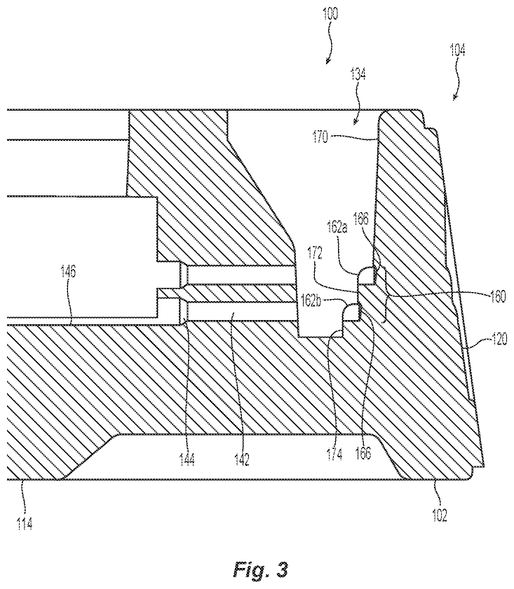

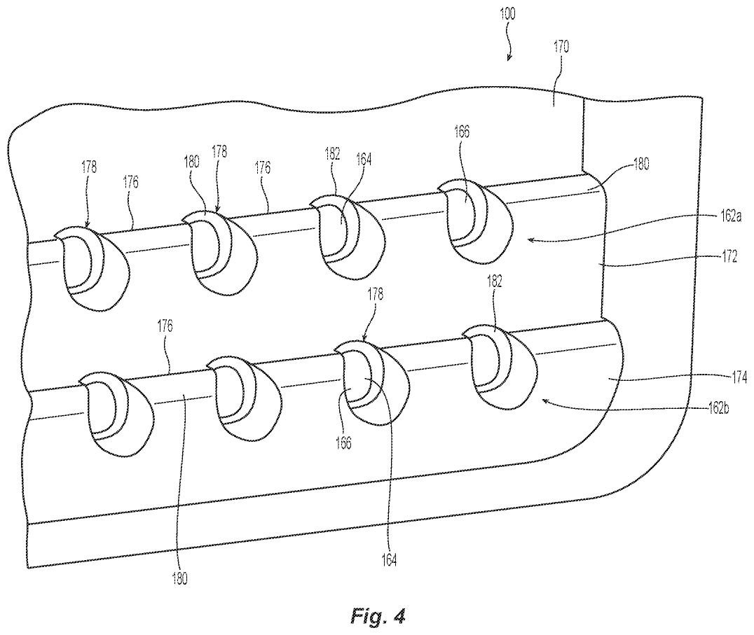

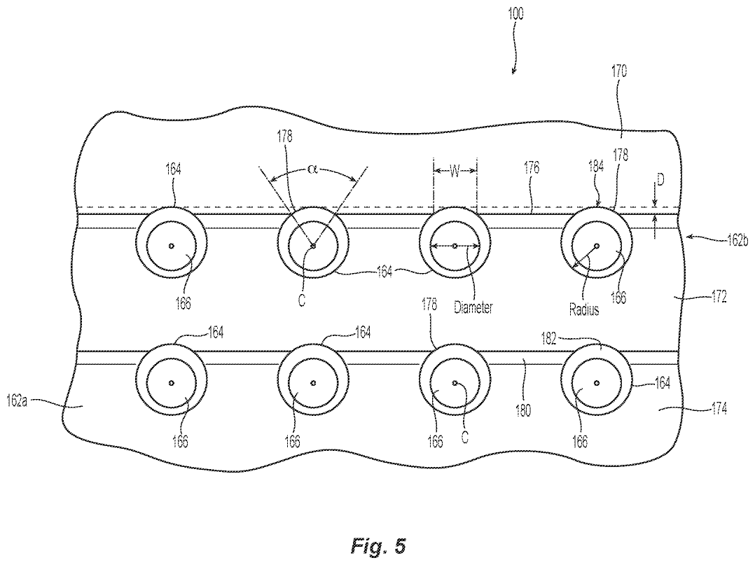

There is a first rearward facing wall 170 and a second rearward facing wall 172. See FIGS. 3-5. There may also be a third rearward facing wall 174, which is similar to, if not identical to, the second rearward facing wall 172. It should be noted that there is a ledge 176 at the top of each of the second and third rearward facing walls 172,174. The blind holes 164 are formed through a portion of the first rearward facing wall 170 and the second rearward facing wall 172. If there is an additional row of optical fibers 110, the blind holes 164 are also formed through a portion of the second rearward facing wall 172 and the third rearward facing wall 174. See FIG. 4 in particular. As a result of the blind holes 164 going through both a portion of the first rearward facing wall 170 and the second rearward facing wall 172, the ledge 176 of the second rearward facing wall 172 at the top of the blind holes 164 thereof is missing and creates a slot 178, and hence a slotted blind hole 164. The slot 178 gives the blind hole 164 a horse-shoe shape when viewed in profile or elevation. The presence of the slot 178 in each of such blind holes 164 allows for better epoxy flow as epoxy is heated during curing, and thereby avoidance of any air gaps when the epoxy cools down post-curing. Accordingly, the blind holes 164 may interchangeably be referred to as slotted blind holes 164 herein. It is clear that the size of the slot 178 can be altered my moving the blind holes 164 vertically within the second window 134. For example, moving the blind holes 164 upward on the rearward facing walls 172,174 and relative to the ledge 176 causes the slot to be larger, while moving them downward narrows the slots 178. Refer to FIG. 5 where if the blind holes 164 are moved upward relative to the ledge 176, then the width W will be larger and if they are moved downward, then the width W would be smaller. Naturally, the rearward facing walls 172,174 could move relative to the blind holes to achieve the same result. That is, the ledge 176 could move upward relative to the blind holes 164, causing the width W to be smaller or moved downward to make the width W larger. It should also be noted that there is a rounded corner 180 between the ledge 176 and the face of the second rearward facing wall 172 and also between the ledge and the face of the third rearward facing wall 174, but the corner could be of any configuration. See FIG. 4.

The blind holes 164 have an angled entrance surface 166 and there may also be a chamfered portion 182 to assist in inserting the optical fibers 110 within the blind holes 164. This allows for the portion of the blind holes 164 within the second rearward facing wall 172 to be larger and therefore easier to place the optical fiber within the blind holes 164.

The same principles apply to the blind holes 164 that are present in the second rearward facing wall 172 and the third rearward facing wall 174. That is, there is a slot 178 that is formed at the top of the third rearward facing wall 174. While the two rows 162a,162b of blind holes 164 are positioned in the same relationship to the rearward facing walls 170, 172, 174, they could be formed differently. That is, one row may be higher relative to the ledge 176 than another row.

With regard to FIG. 5, the slot 178 can be defined in a number of different ways, all of which are within the scope of the invention. The first manner is that the slot 178 subtends an angle α from the center C of each of the blind holes 164, the angle α being much less than 180 degrees. Preferably, the angle α is less than 5 degrees and more preferably between 0.2 and 1 degree.

A second manner is to limit the width W of the slot 178 at the top of the blind holes 164. The width W of the slot 178 is much less than the diameter of the blind hole 164. It is preferably from a few microns to a few tens of microns. Thus, the width W of the slot 178 is smaller than a diameter of the slotted blind hole 164 in a lateral dimension between the two opposing side surfaces 116, 118 of the main body 102.

Finally, the third method is to define the slot 178 is the distance D that an upper most part 184 of the blind hole 164 is from the ledge 176. The distance D is much less than the radius of the blind hole 164 and is always less than the diameter of the blind hole 164. In contrast, the u-grooves 146 have an angle that is almost 180 degrees, making it easy for the optical fibers 110 to slip out therefrom (assuming the u-grooves 146 were the only optical fiber support structures provided). That is, the relatively small size or width W of the slot 178 ensures secure grip on the optical fibers 110 preventing slippage out of the blind hole 164.

In an alternative, the second set of optical fiber support structures 160 with the slotted blind holes 164 may be provided as a standalone structure similar to a plate without any of the first set of optical fiber support structures 132.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

I claim:

1. A fiber optic ferrule comprising:
a main body having a front end and a rear end, and a top side, the rear end having a rear opening to receive at least two optical fibers;
at least one window on the top side;
a first set of optical fiber support structures in the main body disposed between the front end and the rear end and configured to receive the at least two optical fibers; and
a second set of optical fiber support structures in the main body disposed between the front end and the first set of optical fiber support structures and configured to receive the at least two optical fibers from the first set of optical fiber support structures, the second set of optical fiber support structures aligned with the first set of optical fiber support structures along a longitudinal axis between the front and the rear end of the fiber optic ferrule, and the second set of optical fiber support structures includes a plurality of blind holes configured to respectively receive the at least two optical fibers,
wherein there is a first rearward facing wall lying in a first plane and a second rearward facing wall lying in a second plane, the first rearward facing wall and the second rearward facing wall off-set from each other, each of the plurality of blind holes passes through a portion of the first rearward facing wall and a portion of the second rearward facing wall, and wherein each of the plurality of blind holes has a slot at a top thereof.

2. The fiber optic ferrule according to claim 1, further comprising an end face at the front end of the fiber-optic ferrule through which one or more optical beams to and/or from the at least two optical fibers pass.

3. The fiber optic ferrule according to claim 1, wherein each of the plurality of blind holes has a radius and the slot at the top has a first distance that is less than the radius of each of the blind holes.

4. The fiber optic ferrule according to claim 1, wherein the slot at the top of each of the plurality of blind holes subtends an angle α from a center of each of the blind hole.

5. The fiber optic ferrule according to claim 4, wherein the angle α is less than 180 degrees.

6. The fiber optic ferrule according to claim 4, wherein the angle α is less than 5 degrees.

7. The fiber optic ferrule according to claim 4, herein each of the plurality of blind holes has a uppermost portion, the uppermost portion is a second distance from the top of the second rearward facing wall.

8. The fiber optic ferrule according to claim 7, wherein the second distance is less than 10 microns.

9. The fiber optic ferrule according to claim 1, further comprising a third rearward facing wall, the third rearward facing wall lying in a third plane, the first, second, and third rearward facing walls being parallel to but off-set from each other, a first plurality of the plurality of blind holes passes through a portion of the first rearward facing wall and a portion of the second rearward facing wall, and a second plurality of the plurality of the blind holes passes through a portion of the second rearward facing wall and the third rearward facing wall, and wherein each of the second plurality of blind holes also has a slot at a top thereof.

10. A fiber optic ferrule comprising:
a main body having a front end and a rear end, a top side, the rear end having a rear opening to receive at least two optical fibers and epoxy;
a first set of optical fiber support structures in the main body disposed between the front end and the back end and configured to receive the at least two optical fibers;
a second set of optical fiber support structures in the main body disposed between the front end and the first set of optical fiber support structures and configured to receive the at least two optical fibers from the first set of optical fiber support structures, the second set of optical fiber support structures aligned with the first set of optical fiber support structures along a longitudinal axis between the front and the rear end of the fiber optic ferrule,
wherein the second set of optical fiber support structures includes at least two slotted blind holes configured to respectively receive the at least two optical fibers rearward of an entrance surface of the at least two slotted blind holes, the at least two slotted blind holes each has a slot for epoxy flow, and
an end face at the front end of the fiber-optic ferrule through which one or more optical beams to and/or from the at least two optical fibers pass through.

11. The fiber optic ferrule according to claim 10, wherein each of the at least two slotted blind holes passes through a portion of a first rearward facing wall and also through a portion of a second rearward facing wall, the first rearward facing wall and the second rearward facing wall are parallel to and offset from one another and each of the at least two slotted blind holes has a slot on a top thereof.

12. The fiber optic ferrule according to claim 11, wherein each of the at least two slotted blind holes has a diameter and the slot at the top of the second rearward facing wall has a width that is less than the diameter of each of the blind holes.

13. The fiber optic ferrule according to claim 11, wherein the slot at the top of each of the second rearward facing walls subtends an angle α from a center of each of the at least two slotted blind holes.

14. The fiber optic ferrule according to claim 12, wherein the angle α is less than 180 degrees.

15. The fiber optic ferrule according to claim 13, wherein the angle α is in a range of about 0.2-1 degrees.

16. The fiber optic ferrule according to claim 12, wherein each of the at least two slotted blind holes has a uppermost portion, the uppermost portion is a second distance from the top of the second rearward facing wall.

17. The fiber optic ferrule according to claim 16, wherein the second distance is less than 10 microns.

18. A fiber optic ferrule comprising:
a main body having a front end and a rear end, a top side, a bottom side and two opposing side surfaces joining the top side and the bottom side between the front end and the rear end, the fiber optic ferrule configured to receive at least two optical fibers;
a set of optical fiber support structures in the main body disposed between the front end and rear end, the set of optical fiber support configured to receive the at least two optical fibers along a longitudinal axis between the front and the rear end of the fiber optic ferrule,
wherein the set of optical fiber support structures includes slotted blind holes configured to respectively receive the at least two optical fibers rearward of an entrance surface of the slotted blind hole, the slotted blind hole having a slot for epoxy flow; and
an end face at the front end of the fiber-optic ferrule through which one or more optical beams to and/or from the at least two optical fibers pass through.

19. The fiber optic ferrule according to claim 18, wherein the slot is smaller than a diameter of the slotted blind hole in a lateral dimension between the two opposing side surfaces.

20. The fiber optic ferrule according to claim 18, wherein the slot subtends an angle less than 180 degrees from the center of each of the slotted blind holes.
